(19) United States
(12) Patent Application Publication
(10) Pub. No.: US 2009/0081500 A1
(43) Pub. Date: Mar. 26, 2009

(54) FUEL CELL UTILIZING AMMONIA, ETHANOL OR COMBINATIONS THEREOF

(75) Inventor: Gerardine G. Botte, Athens, OH (US)

Correspondence Address: CALFEE HALTER & GRISWOLD, LLP, 800 SUPERIOR AVENUE, SUITE 1400, CLEVELAND, OH, 44114, US

(73) Assignee: Ohio University, Athens, OH (US)

(21) Appl. No.: 12/114,780

(22) Filed: May 4, 2008

Related U.S. Application Data
(63) Continuation-in-part of application No. 10/962,894, filed on Oct. 12, 2004, now Pat. No. 7,485,211.
(60) Provisional application No. 60/916,222, filed on May 4, 2007.
(60) Provisional application No. 60/974,766, filed on Sep. 24, 2007.
(60) Provisional application No. 60/510,473, filed on Oct. 10, 2003.

(30) Foreign Application Priority Data
Jun. 5, 2005 (US) PCT/US06/17641

(51) Int. Cl. H01M 8/18; H01M 8/04; H01M 8/10

(52) U.S. Cl. 429/21; 429/23; 429/26; 429/30

(57) ABSTRACT

An fuel cell utilizing ammonia, ethanol, or combinations thereof, comprising: a housing; an anode disposed within the housing, the anode comprising at least one layered electrocatalyst, wherein the at least one layered electrocatalyst comprises at least one active metal layer and at least one second metal layer deposited on a carbon support; a basic electrolyte disposed adjacent the anode; a cathode disposed adjacent the basic electrolyte, wherein the cathode comprises a conductor; and an oxidant in communication with the cathode for connecting with a power conditioner, a load, or combinations thereof, wherein the power conditioner, the load, or combinations thereof is in communication with the anode, which oxidizes the ammonia, ethanol, or combinations thereof, causing the fuel cell to form an electric current.

### CROSS-REFERENCE TO RELATED APPLICATIONS

The present application claims priority to the provisional application having application Ser. No. 60/916,222, to the provisional application having the application Ser. No. 60/974,766, to the PCT application WO/2006/121981, which in turn claims priority to the provisional application having Ser. No. 60/678,725, and to the utility application having the application Ser. No. 10/962,894, which in turn claims priority to the provisional application having Ser. No. 60/510,473, the entirety of which are incorporated herein by reference.

### FIELD

The present embodiments relate to a fuel cell for the production of electrical energy utilizing ammonia, ethanol, or combinations thereof.

### BACKGROUND

A need exists for a fuel cell able to oxidize ammonia, ethanol, or combinations thereof in alkaline media continuously.

A further need exists for a fuel cell that utilizes an anode having a unique layered electrocatalyst that overcomes the positioning of the electrode due to surface blockage and enables operation of the fuel cell at low temperatures.

A need also exists for a fuel cell that utilizes a layered electrocatalyst with a carbon support that provides a hard rate of performance for the carbon support.

The present embodiments meet these needs.

### BRIEF DESCRIPTION OF THE DRAWINGS

The detailed description will be better understood in conjunction with the accompanying drawings as follows:

FIG. 1 depicts an embodiment of the present fuel cell.

FIG. 2 depicts an embodiment of an electric device assemblage powered by a fuel cell stack.

FIG. 3 shows adsorption of OH on a Platinum cluster.

FIG. 4 shows experimental results of the electro-oxidation of ammonia on a Pt electrode, using a rotating disk electrode.

FIG. 5 shows results of microscopic modeling of the electro-adsorption of OH, indicating that if the sites were available, the adsorption of OH would continue producing higher oxidation currents

FIG. 6 shows a representation of the electro-oxidation mechanism of ammonia on a Pt electrode. As NH3 reaches the Pt surface it competes with the OH″ electro-adsorption. Since the Electro-adsorption of OH″ is faster on Pt the active sites of the electrode get saturated with the OH adsorbates causing deactivation of the electrode.

FIG. 7 shows a schematic representation of the procedure used to increase the electronic conductivity of the carbon fibers during plating and operation.

FIG. 8 shows SEM photographs of the carbon fibers before plating and after plating.

FIG. 9 shows cyclic voltammetry performance of 1M Ammonia and 1M KOH solution at 25° C., comparing the performance of the carbon fiber electrodes with different compositions.

FIG. 10 shows cyclic voltammetry performance of 1M Ammonia and 1M KOH solution at 25° C., comparing the loading of the electrode, with low loading 5 mg of total metal/cm of carbon fiber and high loading 10 mg of metal/cm of carbon fiber.

FIG. 11 shows cyclic voltammetry performance of 1M Ammonia and 1M KOH solution at 25° C., comparing differing electrode compositions at low loading of 5 mg of total metal/cm of fiber. Electrode compositions include High Rh, Low Pt (80% Rh, 20% Pt), and low Rh and high Pt (20% Rh, 80% Pt).

FIG. 12 shows cyclic voltammetry performance of 1M Ammonia and 1M KOH solution at 25° C., with differing ammonia concentration, indicating that the concentration of NH3 does not affect the kinetics of the electrode.

FIG. 13 shows cyclic voltammetry performance of Effect of solution at 25° C., with differing OH concentration, indicating that a higher the concentration of OH causes faster kinetics.

FIG. 14 shows cyclic voltammetry performance of 1M ethanol and 1M KOH solution at 25° C., indicating that the present electrochemical cell is also useable for the continuous oxidation of ethanol.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments relate to a fuel cell that utilizes ammonia, ethanol, or combinations thereof for producing electrical current.

Conventional hydrogen production is expensive, energy inefficient, and creates unwanted byproducts. Further, current sources and processes for hydrogen production require high operating temperatures and complicated processes, and often produce gas having impurities.

The present fuel cell provides the benefit of continuous power generation based on renewable alternative fuels, such as ammonia, ethanol, or combinations thereof, that can operate at low temperatures, and/or low pressure, through use of a layered electrocatalyst as an anode.

Hydrogen is the main fuel source for power generation using fuel cells, but the effective storage and transportation of hydrogen presents technical challenges. Current hydrogen production costs cause fuel cell technology for distributed power generation to be economically non-competitive when compared to traditional oil-fueled power systems. Current distributed hydrogen technologies are able to produce hydrogen at costs of $5 to $6 per kg of H2. This high production cost is due in part to high product separation/purification costs and high operating temperatures and pressures required for hydrogen production.

Using current technologies, hydrogen can be obtained by the partial oxidation, catalytic steam reforming, or thermal reforming of alcohols and hydrocarbons. However, all of these processes take place at high temperatures and generate a large amount of CO_{X} as byproducts, which must be removed from the hydrogen product. Most of these CO_{X} byproducts cause degeneration of fuel cell performance due to poisoning of the fuel cell catalysts. The removal of these byproducts from the fuel stream is complicated, bulky, and expensive.

Currently, the cleanest way to obtain pure hydrogen is by the electrolysis of water. During the electrolysis of water electrical power (usually provided by solar cells) is used to break the water molecule, producing both pure oxygen and hydrogen. The disadvantage of this process is that a large amount of electrical power is needed to produce hydrogen. The theoretical energy consumption for the oxidation of water is 66 W-h per mole of Ĥ produced (at 25° C.). Therefore, if solar energy is used (at a cost of $0.2138/kWh), the theoretical cost of hydrogen produced by the electrolysis of water is estimated to be $7 per kg of H2.

The present fuel cell overcomes the costs and difficulties associated with the production of hydrogen, by enabling continuous, controllable production of electric current using plentiful and inexpensive feedstocks that include ammonia and/or ethanol.

Plating of carbon fibers, nano-tubes, and other carbon supports is a difficult task that is problematic due to the relatively low electronic conductivity of these materials. The low conductivity of carbon supports can cause a poor coating of the surface of the support, which can be easily removed. The electronic conductivity of carbon fibers and other carbon supports decreases along the length from the electrical connection. Therefore, the furthest point of contact to the electric connection transfers a low current when compared with the closest point to the electric contact.

The present fuel cell advantageously utilizes a unique layered electrocatalyist that provides electrodes with uniform current distribution, enhanced adherence and durability of coating, and overcomes surface coverage affects, leaving a clean active surface area for reaction. The layered electrocatalyst further enables the fuel cell to operate at lower temperatures than conventional fuel cells.

It was believed that the surface blockage caused during the ammonia electrolysis in alkaline medium was due to the presence of elemental Nitrogen, according to the mechanism proposed by Gerisher:

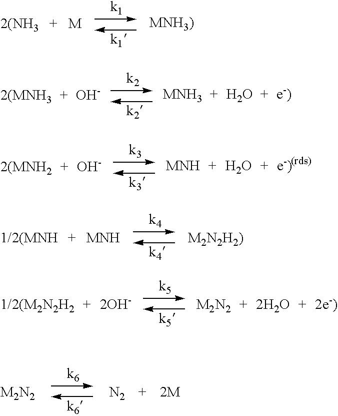

Deactivation Reaction:

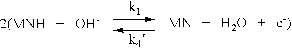

where M represents an active site on the electrode.

The present fuel cell incorporates the demonstrations of two independent methods indicating that the proposed mechanism by Gerisher is not correct, and that OH needs to be adsorbed on the electrode for the reactions to take place. Furthermore, the electrode is deactivated by the OH adsorbed at the active sites.

Results from molecular modeling indicate that the adsorption of OH on an active Pt site is strong (chemisorption) and can be represented by the following reaction:

Pt₁₀+OH⁻ [symbol] Pt₁₀−OH_{(αd)+}e⁻

FIG. 3 shows the bond between the OH and the platinum cluster. The system was modeled using Density functional Methods. The computations were performed using the B3PW91 and LANL2DZ method and basis set, respectively. The binding energy for the Pt—OH cluster is high with a value of −133.24 Kcal/mol, which confirms the chemisorption of OH on a Pt cluster active site.

Additionally, results from microscopic modeling as well as experimental results on a rotating disk electrode (RDE) indicate that the adsorption of OH is strong and responsible for the deactivation of the catalyst.

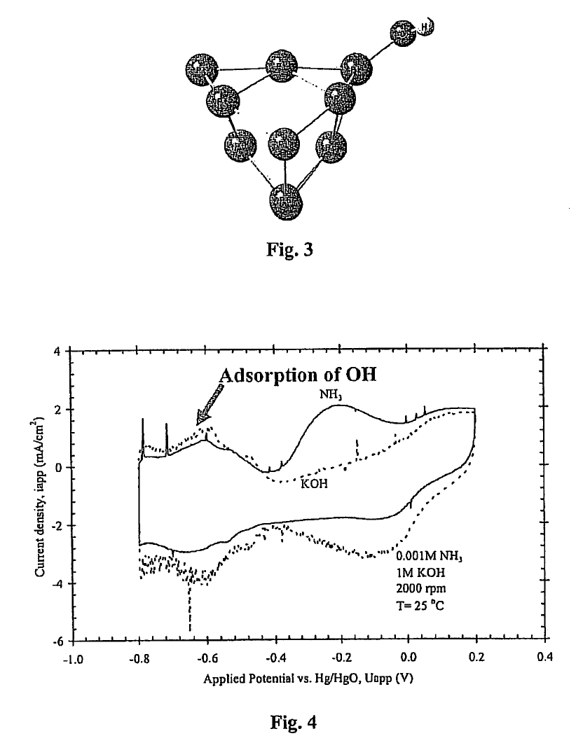

FIG. 4 compares the baseline of a KOH solution with the same solution in the presence of OH. The curves indicate that the first oxidation peaks that appear at about −0.7 V vs Hg/HgO electrode had to do with the electro-adsorption of OH.

FIG. 5 shows a comparison of the predicted results (by microscopic modeling) with the experimental results for the electro-adsorption of OH. The results indicate that the model predict the experimental results fairly well. Furthermore, an expression for the surface blockage due to the adsorption of OH at the surface of the electrode was developed (notice that the active sites for reaction theta decay with the applied potential due to adsorbates). If the surface were clean (see results Model without coverage), the electro-adsorption of OH would continue even at higher potentials and faster.

Compiling the experimental results with the modeling results the following mechanism for the electro-oxidation of ammonia in alkaline medium is proposed: First the adsorption of OH takes place. As the ammonia molecule approaches the electrode, it is also adsorbed on the surface. Through the oxidation of ammonia, some OH adsorbates are released from the surface in the form of water molecule. However, since the adsoiption of OH is stronger and the OH ions move faster to the surface of the electrode, they are deactivated increasing potential. There will be a competition on the electrode between the adsorption of OH and NH3.

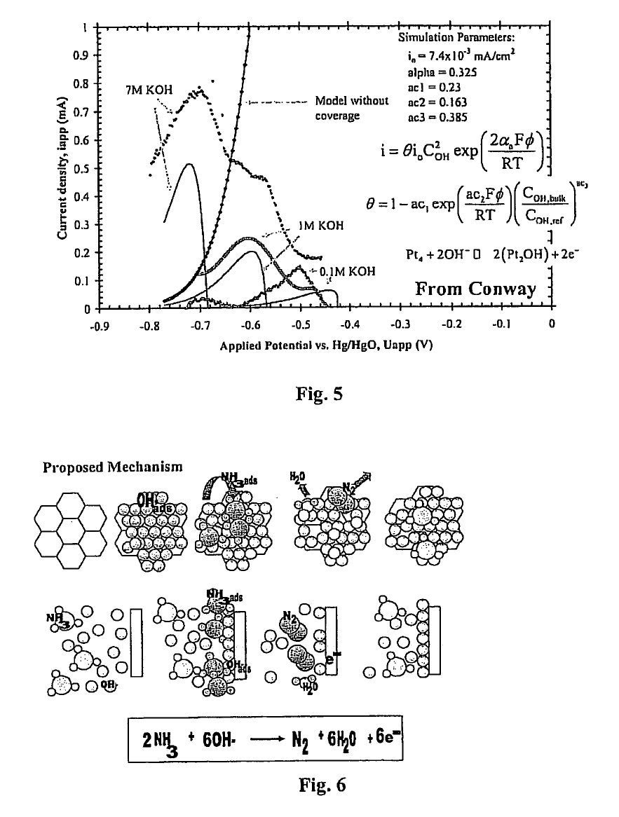

The results of the mechanism are summarized on the proposed reactions given below, as well as FIG. 6.

Pt₁₀+OH⁻ [symbol] Pt₁₀−OH⁻_{(αd)} (1)

2Pt₁₀+2NH₃ [symbol] 2Pt₁₀−NH_{3(ad)} (2)

Pt₁₀−NH_{3(ad)}+Pt₁₀−OH⁻_{(ad)} [symbol] Pt₁₀−NH_{2(ad)}+Pt₁₀+H₂O+e⁻ (3)

Pt₁₀−NH_{2(ad)}+Pt₁₀−OH⁻_{(ad)} [symbol] Pt₁₀−N_{(ad)}+Pt₁₀+H₂O+e⁻ (4, rds)

Pt₁₀−NH_{(ad)}+Pt₁₀−OH⁻_{(ad)} [symbol] Pt₁₀−N_{(ad)}+Pt₁₀+H₃O+e⁻ (5)

2Pt₁₀−N_{(ad)} [symbol] Pt₁₀−N_{3(ad)}+Pt₁₀ (6)

Pt₁₀−N_{2(ad)} [symbol] Pt₁₀+N_{2(g)} (7)

This mechanism can be extended to the electro-oxidation of other chemicals in alkaline solution at low potentials (negative vs. SHE). For example, it has been extended to the electro-oxidation of ethanol. The proposed mechanism clearly defines the expectations for the design of better electrodes: the materials used should enhance the adsorption of NH3 and/or ethanol, or other chemicals of interest. The proposed mechanism can also enhance the electrolysis of water in alkaline medium. It is necessary a combination of at least two materials: One of the materials should be more likely to be adsorbed by OH than the other; this will leave active sites available for the electro-oxidation of the interested chemicals, such as NH₃ and/or ethanol.

The present fuel cell includes a housing, which can be made from any nonconductive material, including polypropylene, Teflon or other polyamides, acrylic, or other similar polymers. The housing can have any shape, size, or geometry, depending on the volume of liquid to be contained in the fuel cell, and any considerations relating to stacking, storage, and/or placement in a facility.

The housing can include any number of inlets and/or outlets. Outlets can receive gasses produced at the anode and/or cathode and can be used to remove liquid from the fuel cell. Inlets can be used to provide basic electrolyte, ammonia and/or ethanol, oxidant, or combinations thereof, simultaneously or separately.

The housing can be sealed, such as by using one or more gaskets, including gaskets made from Teflon or other polyamides, a sealant, a second housing, or combinations thereof.

An anode is disposed within the housing. The anode includes a layered electrocatalyst, which includes at least one active metal layer and at least one second metal layer deposited on a carbon support. The carbon support can be integrated with a conductive metal, such as titanium, tungsten, nickel, stainless steel, or other similar conductive metals.

It is contemplated that the conductive metal integrated with the carbon support can have an inability or reduced ability to bind with metal plating layers used to form the layered electrocatalyst.

The active metal layer is contemplated to have a strong affinity for the oxidation of ammonia, ethanol, or combinations thereof. The second metal layer is contemplated to have a strong affinity for hydroxide. The affinities of the layers enhance the electronic conductivity of the carbon support, and facilitate the operation of the fuel cell at low temperatures.

In a contemplated embodiment, the second metal layer can be a second layer of an active metal, such that the layered electrocatalyst includes two active metal layers deposited on the carbon support.

The carbon support can include carbon fibers, carbon tubes, carbon microtubes, carbon microspheres, carbon sheets, carbon nanofibers, carbon nanotubes, or combinations thereof. For example, groups of carbon nanofibers bound in clusters of 6,000, wound on titanium, nickel, carbon steel, or other similar metals, could be used as a carbon support.

Carbon fibers can include woven or non-woven carbon fibers, that are polymeric or other types of fibers. For example, a bundle of polyacrylonitrile carbon fibers could be used as a carbon support. Solid or hollow nano-sized carbon fibers, having a diameter less than 200 nanometers, can also be useable. Bundles of 6000 or more carbon fibers are contemplated, having an overall diameter up to or exceeding 7 micrometers.

Carbon microspheres can include nano-sized Buckyball supports, such as free standing spheres of carbon atoms having plating on the inside or outside, having a diameter less than 200 nanometers. Crushed and/or graded microspheres created from the grinding or milling of carbon, such as Vulcan 52, are also useable.

Carbon sheets can include carbon paper, such as that made by Toray™, having a thickness of 200 nanometers or less. Useable carbon sheets can be continuous, perforated, or partially perforated. The perforations can have diameters ranging from 1 to 50 nanometers.

Carbon tubes can include any type of carbon tube, such as nano-CAPP or nano-CPT, carbon tubes made by Pyrograf®, or other similar carbon tubes. For example, carbon tubes having a diameter ranging from 100 to 200 nanometers and a length ranging from 3,000 to 100,000 nanometers could be used.

The metal layers can be deposited on the carbon support through sputtering, electroplating, such as through use of a hydrochloric acid bath, vacuum electrodeposition, other similar methods, or combinations thereof.

The active metal layer can include rhodium, rubidium, iridium, rhenium, platinum, palladium, copper, silver, gold, nickel, iron, or combinations thereof.

The second metal layer can include platinum, iridium, or combinations thereof. The ratio of platinum to iridium can range from 99.99:0.01 to 50:50. In an embodiment, the ratio of platinum can range from 95:5 to 70:30. In other embodiments, the ratio of platinum to iridium can range from 80:20 to 75:25.

Each layer can be deposited on the carbon support in a thickness ranging from 10 nanometers to 10 microns. For example, a loading of at least 2 mg/cm for each layer can be provided to a carbon fiber support, while both layers can provide a total loading ranging from 4 mg/cm to 10 mg/cm.

Each layer can wholly or partially cover the carbon support. Each layer can be perforated. Each layer can have regions of varying thickness.

It is contemplated that the thickness and coverage of each layer can be varied to accommodate the use a specified ammonia or ethanol feedstock. The present fuel cell can thereby be customized to meet the needs of users.

A basic electrolyte is disposed within the housing in contact with the anode. The basic electrolyte can include any alkaline electrolyte that is compatible with the layered electrocatalyist, does not react with ammonia or ethanol, and has a high conductivity.

The basic electrolyte can include any hydroxide donor, such as inorganic hydroxides, alkaline metal hydroxides, or alkaline earth metal hydroxides. In an embodiment the basic electrolyte can include potassium hydroxide, sodium hydroxide, or combinations thereof.

The basic electrolyte can have a concentration ranging from 0.1 M to 7M. In an embodiment, the basic electrolyte can have a concentration ranging from 3M to 7M. It is contemplated that the basic electrolyte can be present in a volume and/or concentration that exceeds the stoichiometric proportions of the oxidation reaction, such as two to five times greater than the concentration of ammonia, ethanol, or combinations thereof. In an embodiment, the basic electrolyte can have a concentration three times greater than the amount of ammonia and/or ethanol.

The fuel cell can also include ammonia, ethanol, or combinations thereof, disposed within the housing in communication with the anode.

The present fuel cell can advantageously utilize any combination of ammonia or ethanol, independently or simultaneously. A feedstock containing either ammonia, ethanol, or both ammonia and ethanol could be thereby be utilized by the present fuel cell. Additionally, separate feedstocks containing ammonia and ethanol could be individually or simultaneously utilized using the fuel cell.

The ammonia, ethanol, or combinations thereof can be present in extremely small quantities, millimolar concentrations, and/or ppm concentrations, while still enabling the present fuel cell to be useable.

The ammonia and/or ethanol can be aqueous, having water, the basic electrolyte, or another liquid as a carrier. For example, ammonium hydroxide can be stored until ready for use, then fed directly into the fuel cell.

It is also contemplated that ammonia can be stored as liquefied gas, at a high pressure, then combined with water and the basic electrolyte when ready for use. Ammonia could also be obtained from ammonium salts, such as ammonium sulfate, dissolved in the basic electrolyte.

In an embodiment, the ammonia, ethanol, or combinations thereof can have a concentration ranging from 0.01 M to 5M. In other embodiments, the concentration of ammonia, ethanol, or combinations thereof, can range from 1M to 2M. At higher temperatures, a greater concentration of ammonia can be used. The properties of the present fuel cell, such as the thickness of the plating of the anode, can be varied to accommodate the concentration of the feedstock.

The ability of the present fuel cell to utilize both extremely small and large concentrations of ammonia and/or ethanol enables the fuel cell to advantageously accommodate a large variety of feedstocks.

The reaction performed by the present fuel cell is exothermic. As a result, the fuel cell can be used to heat other adjacent or attached devices and equipment, such as adjacent electrochemical cells performing endothermic reactions, creating a beneficial, synergistic effect.

The present fuel cell also includes a cathode, which includes a conductor, disposed within the housing in contact with the basic electrolyte. The cathode can include carbon, platinum, rhenium, palladium, nickel, Raney Nickel, iridium, vanadium, cobalt, iron, ruthenium, molybdenum, other similar conductors, or combinations thereof.

It is further contemplated that the present fuel cell can be constructed such that the housing can itself function as the cathode. For example, the housing could be formed at least partially from nickel.

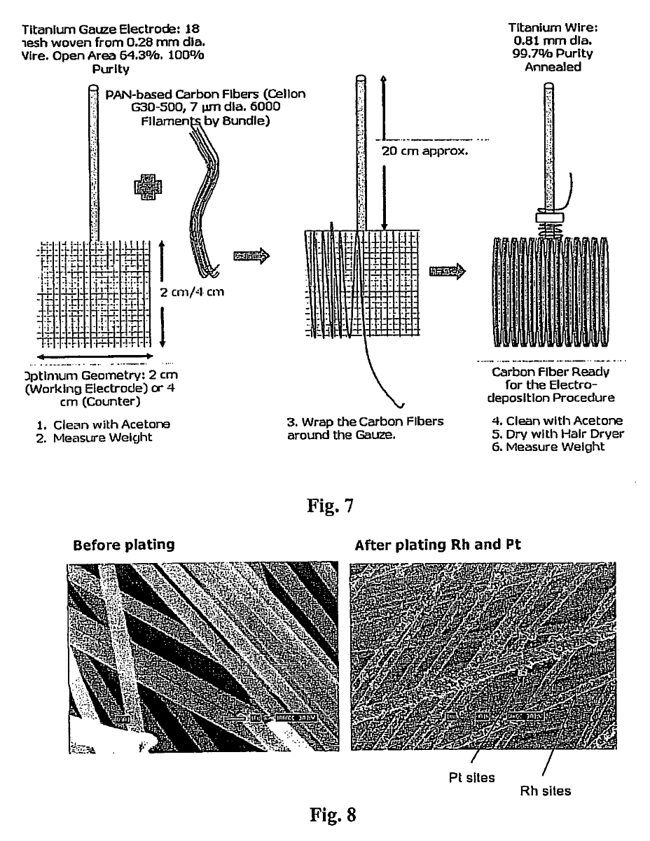

FIG. 7 shows a schematic representation of the procedure used to increase the electronic conductivity of the carbon fibers during plating (and also during the operation of the electrode). The fibers were wrapped on a titanium gauze, and were therefore in electric contact with the metal at different points. This improvement allowed an easy and homogenous plating of the fibers at any point. The electronic conductivity at any point in the fiber was the same as the electronic conductivity of the Ti gauze.

FIG. 8 shows a Scanning Electron Microscope photograph of the electrode before plating and after plating. A first layer of Rh was deposited on the electrode to increase the electronic conductivity of the fibers and to serve as a free substrate for the adsorption of OH. (OH has more affinity for Rh than for Pt). A second layer consisting of Pt was plated on the electrode. The Pt layer did not cover all the Rh sites, leaving the Rh surface to act as a preferred OH adsorbent.

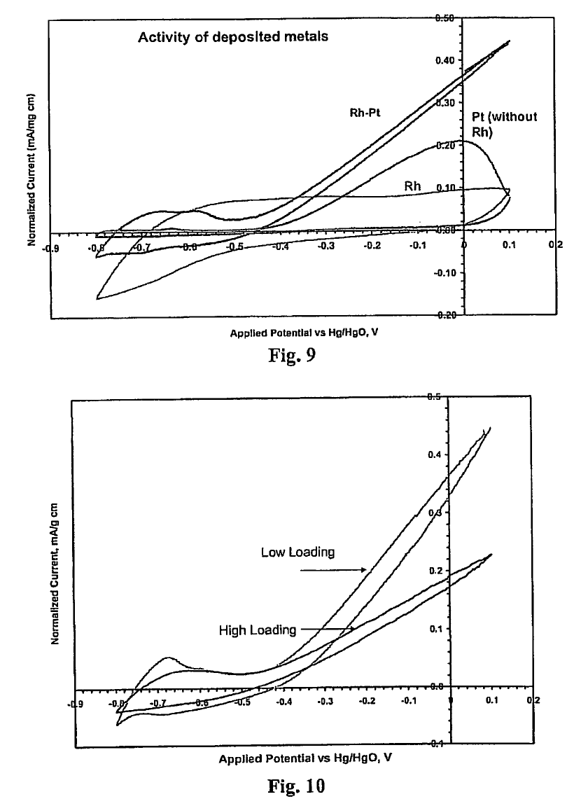

FIG. 9 shows the cyclic voltammetry performance for the electro-oxidation of ammonia on different electrode compositions. Notice that the carbon fibers plated with only Rh are not active for the reaction, while when they are plated with only Pt, the electrode is active but it is victim of poisoning. On the other hand, when the electrode is made by plating in layers: first Rh is deposited and then a second layer consisting of Pt is deposited, the electrode keeps the activity. This is explained by the mechanism presented previously. FIG. 9 demonstrates that the proposed method or preparation of the electrode eliminates surface blockage difficulties.

FIG. 10 shows the effect of different total loading on the electro-oxidation of ammonia. The results indicate that the catalyst with the lowest loading is more efficient for the electro-oxidation of ammonia. This feature results in a more economical process owing to a lower expense related to the catalyst. Additional loading of the catalyst just causes the formation of layers over layers that do not take part in the reaction.

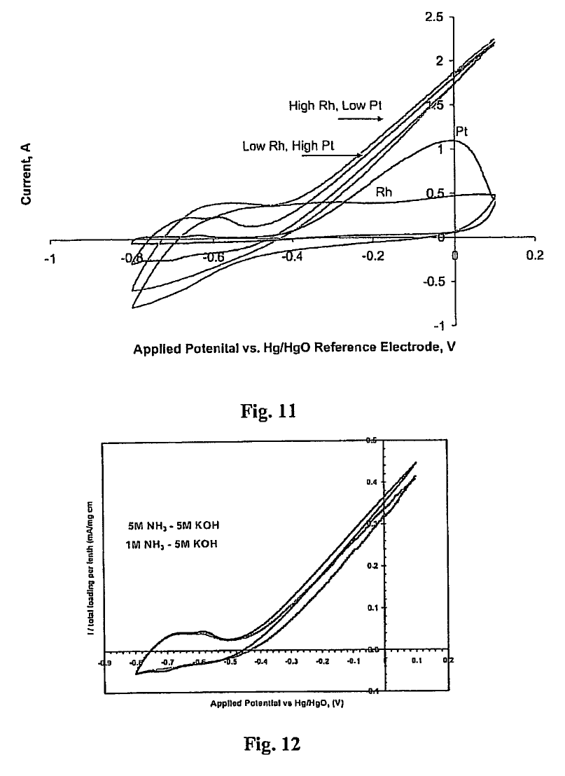

FIG. 11 illustrates the effect of the catalyst composition of the electro-oxidation of ammonia in alkaline solution. There is not a notable difference in the performance of the electrode due to the composition of the electrode. This lack of difference is due to the fact that as long as a first layer of Rh is plated on the electrode, surface blockage will be avoided. Additional plating of Pt would cause the growth of a Pt island (see SEM picture, FIG. 8), which is not completely active in the whole surface.

FIG. 12 shows the effect of ammonia concentration on the performance of the electrode. The effect of ammonia concentration is negligible on the electrode performance. This is due to the fact that the active Pt sites have already adsorbed the NH3 needed for a continuous reaction. Due to this feature, the present fuel cell is operable using only trace amounts of ammonia and/or ethanol.

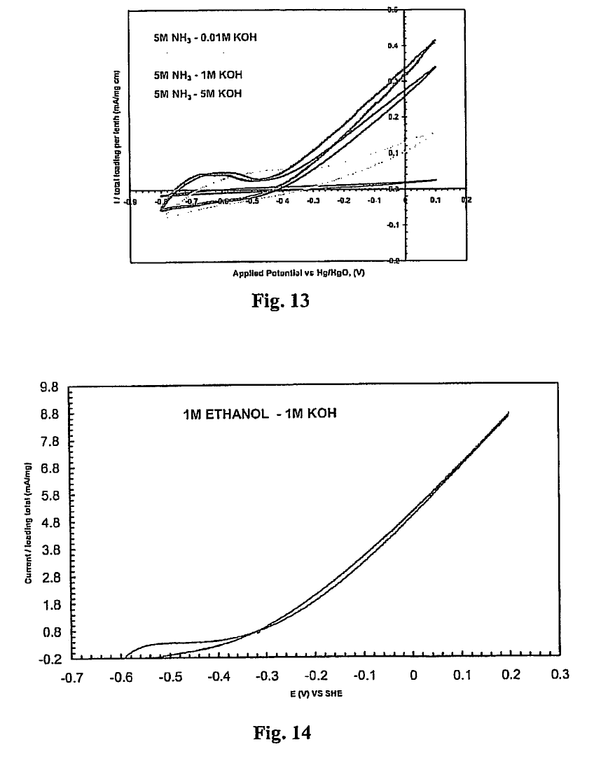

FIG. 13 depicts the effect of the concentration of OH on the electro-oxidation of ammonia. A larger concentration of OH causes a faster rate of reaction. The electrode maintains continuous activity, without poisoning, independent of the OH concentration.

FIG. 14 shows the evaluation of the electrode for the electro-oxidation of ethanol. Continuous electro-oxidation of ethanol in alkaline medium is achieved without surface blockage. The present fuel cell is thereby able to use ethanol, as well as ammonia. The present fuel cell can further utilize combinations of ammonia and ethanol independently or simultaneously.

In an embodiment, the second electrode and first electrode can both include a layered electrocatalyst.

The schematic for the construction of the electrode is shown in FIG. 7. The plating procedure includes two steps: 1. First layer plating and 2. Second layer plating.

First layer plating includes plating the carbon support with materials that show a strong affinity for OH. Examples include, but are not limited to Rh, Ru, Ni, and Pd. In one preferred embodiment, Rh is used. The first layer coverage should completely plate the fiber. In some embodiments, the first layer coverage is at least 2 mg/cm of fiber to guarantee a complete plating of the fiber. In other embodiments, the first layer coverage can be 2.5 mg/cm, 3.0 mg/cm, 3.5 mg/cm, or more.

Second layer plating includes plating the electrode with materials that have a strong affinity for the oxidation of ammonia and/or ethanol. Examples include: Pt and Ir. Monometallic deposition and/or bimetallic deposition of these materials can be performed. Ratios of Pt:Ir can range from 100% Pt-0% Ir to 50% Pt-50% Ir.

Table I summarizes the plating conditions for the anode and the cathode of the fuel cell. After plating the Rhodium, the electrode is weighted. The weight corresponds to the Rhodium loading. Then, the Platinum is deposited on top of the Rhodium. After the procedure is completed, the electrode is measured again. The measurement will correspond to the total loading. The Platinum loading is obtained by subtracting the total loading from the previous Rhodium measurement. The relation of Platinum to Rhodium is then calculated as the percentage of fixed loading. Because the loading depends on the length of the fiber, another measurement should be calculated. It is known that 10 cm of fiber weights 39.1 mg, and because the weight of the fiber is known, then by proportionality, it can be known the length of the total fiber that is being used in each electrode.

Table II summarizes the general conditions of a plating bath useable to create the electrodes. During the entire plating procedure, the solution was mixed to enhance the transport of the species to the carbon support.

Table III shows examples of some electrode compositions, lengths, and loadings of active metals.

TABLE 1
Conditions for Electro-plating Technique in the Deposition of Different Metals on
the Carbon Fibers and/or Carbon Nanotubes

| Metal Plated | Rhodium (Rh) | Platinum (Pt) | Nickel (Ni) |
|---|---|---|---|
| Position on the | First | Second | First |
| Electrode Surface: | | | |
| Geometry: | 2 × 2 cm² | 2 × 2 cm² | 4 × 4 cm² |
| Conditions of the | Total Volume: 250 ml | Total Volume: 250 ml | Total Volume: 500 ml |
| Solution: | | | |
| Composition of the | 1 M HCl + | 1 M HCl + Hydrogen | Watt's Bath: |
| Solution: | Rhodium (III) | Hexachloroplatinate (IV) | Nickel Sulphate |
| | Chloride | Hydrate, 99.9% | (NiS0₄•6H₂0) |
| | (RhCl₃•XH₂O)•Rh | (H₂PtCl₆•6H₂O) | 280 g/L Nickel Chloride |
| | 38.5-45.5% (different | (different compositions, | (NiCl₂•6H₂O) |
| | compositions, | depending | 40 g/L Boric Acid |
| | depending | on loadings) | (H₃BO₃) 30 g/L |
| | on loadings) | | |
| Counter Electrode: | Double Platinum | Double Platinum | Nickel Spheres |
| | Foil Purity 99.95% | Foil Purity 99.95% | (6 to 16 mm p.a.) |
| | 20x50x(0.004″) | 20x50x(0.004″) | in contact with a |
| | | | Nickel Foil |
| | | | Electrode 99.9+% |
| | | | Purity (0.125 |
| | | | mm thick) |
| Temperature: | 70° C. | 70° C. | 45° C. |
| Time: | See Applied Current | See Applied Current | 8 h approximately |
| Loading: | 5 mg/cm of Fiber | 5 mg/cm of Fiber | Fixed Pammeter, |
| | | | Between 6-8 mg/ |
| | | | length of fiber |
| Applied Current: | 100 mA (30 min) + | 40 mA (10 min) 4-60 | Stairs from 100 mA, |
| | 120 mA (30-60 min), | (10 min) H-80 mA (10 min) | to 120 mA and then |
| | depending on | 4-100 mA (1-2 h), | to 140 mA |
| | loading | depending on loading | |

TABLE 2
General Conditions of the Plating Bath

| | |
|---|---|
| Pretreatment | Degreasing using acetone |
| Bath Type | Chloride salts in HCl |
| Solution Composition | Metal/metal ratios varied for |
| | optimum deposit composition |
| Applied Current | Galvanostatic (1 to 200 mA) |
| Deposition Time | Varied from 30 minutes to several hours |

TABLE 3
Examples of some Electrode Compositions and Loadings

| | | Ratio | Total | | |
|---|---|---|---|---|---|
| ID | Composition | Pt:Rh | Loading, mg | Lengths, cm | Mg/cm |
| 2x2-1 | 21% Rh-79% Pt | 3.81 | 252.5 | 30.0 | 8.4 |
| 2x2-2 | 30% Rh-70% Pt | 2.31 | 146.0 | 33.4 | 4.4 |
| 2x2-3 | 23% Rh-73% Pt | 3.44 | 151.5 | 30.5 | 5.0 |
| 2x2-4 | 30% Rh-70% Pt | 2.32 | 308.8 | 31.3 | 9.9 |
| 2x2-5 | Rh-Ir-Pt | 1.36 | 196.4 | 38.0 | 5.2 |
| 2x2-6 | 80% Rh-20% Pt | 0.25 | 169.9 | 33.3 | 5.1 |
| 2x2-7 | 100% Rh | — | 157.0 | 31.6 | 5.0 |
| 2x2-8 | 30% Rh-70% Pt | 2.30 | 160.6 | 30.9 | 5.2 |
| 2x2-9 | 100% Pt | — | 161.9 | 32.3 | 5.0 |

The first electrode, second electrode, or combinations thereof, can include rotating disc electrodes, rotating ring electrodes, cylinder electrodes, spinning electrodes, ultrasound vibration electrodes, other similar types of electrodes, or combinations thereof.

An oxidant is disposed within the housing in communication with the cathode, for connecting with a power conditioner, a load, or combinations thereof. The oxidant can include oxygen, air, other oxidizers, or combinations thereof. Pure oxygen is a superior oxidizer, however other oxidizers, including air, can be used to avoid the expense of pure oxygen.

The oxidant used can have a pressure ranging from less than 1 atm to 10 atm.

The power conditioner, load, or combinations thereof, which is in communication with the anode, causes the oxidation of the ammonia, ethanol, or combinations thereof. This oxidation causes the fuel cell to form a current.

The amount of electrical current produced can vary depending on the properties of the cell and/or feedstock, based on the Faraday equation.

The present fuel cell is contemplated to be operable at temperatures ranging from −50 degrees Centigrade to 200 degrees Centigrade. In an embodiment, the fuel cell can be operable from 20 degrees Centigrade to 70 degrees Centigrade. In another embodiment, the cell is operable from 60 degrees Centigrade to 70 degrees Centigrade.

The fuel cell can also be operable from 20 degrees Centigrade to 60 degrees Centigrade, from 30 degrees Centigrade to 70 degrees Centigrade, from 30 degrees Centigrade to 60 degrees Centigrade, or from 40 degrees Centigrade to 50 degrees Centigrade.

It is contemplated that in an embodiment, a higher pressure can be used, enabling the present fuel cell to be operable at higher temperatures.

The present fuel cell is contemplated to be useable at pressures ranging from less than 1 atm to 10 atm.

In an embodiment, the present fuel cell can include an ionic exchange membrane or separator disposed between the anode and the cathode. The ionic exchange membrane or separator can include polypropylene, Teflon or other polyamides, other polymers, glassy carbon, fuel-cell grade asbestos, or combinations thereof. It is contemplated that the ionic exchange membrane or separator can selectively permit the exchange of hydroxide.

It is contemplated that the membrane or separator must remain wet after contacting the solution within the cell to prevent shrinkage, retain orientation of the polymer, and retain the chemical properties of the membrane or separator.

It is further contemplated that the first electrode, the second electrode, or combinations thereof, could be deposited on the separator or membrane, such as by spraying or plating, such that no separate electrodes are required in addition to the separator or membrane.

In an embodiment, the fuel cell can include one or more flow controllers within the housing. The flow controllers can be useable to distribute electrolyte, ammonia, ethanol, and/or oxidant within the cell, and to remove gas bubbles from the surface of the electrodes, increasing the surface area of the electrodes able to be contacted.

The present fuel cell can be used to form one or more fuel cell stacks by connecting a plurality of fuel cells in series, parallel, or combinations thereof.

The fuel cell stack can include one or more bipolar plates disposed between at least two adjacent fuel cells. The bipolar plate can include an anode electrode, a cathode electrode, or combinations thereof. For example, the bipolar plate could function as an anode for both adjacent cells, or the bipolar plate could have anode electrode materials deposited on a first side and cathode electrode materials deposited on a second side.

The fuel cell stack can have any geometry, as needed, to facilitate stacking, storage, and/or placement. Cylindrical, prismatic, spiral, tubular, and other similar geometries are contemplated.

In an embodiment, a single cathode electrode can be used as a cathode for multiple fuel cells within the stack, each cell having an anode electrode.

In this embodiment, at least a first fuel cell would include a first anode having a layered electrocatalyst, as described previously, and a cathode having a conductor.

At least a second of the fuel cells would then have a second anode that includes the layered electrocatalyst. The cathode of the first fuel cell would function as the cathode for both the first and the second fuel cells.

In a contemplated embodiment, a fuel cell stack having a plurality of anode electrodes having the layered electrocatalyist and a single cathode having a conductor can be used. For example, multiple disc-shaped anode electrodes can be placed in a stacked configuration, having single cathode electrode protruding through a central hole in each anode electrode.

A basic electrolyte and ammonia, ethanol, or combinations thereof can then be placed in contact with each of the plurality of anode electrodes and with the cathode electrode.

The described embodiment of the fuel cell stack can further have an inlet in communication with each of the plurality of anodes, simultaneously, such as by extending through the central hole of each of the anodes.

The present embodiments also relate to a hydrogen fuel cell and electrochemical cell stack which include a plurality of hydrogen fuel cells and a plurality of electrochemical cells. Each of the plurality of hydrogen fuel cells and each of the plurality of electrochemical cells are contemplated to include anodes having a layered electrocatalyst, as described previously.

The fuel cells and electrochemical cells can also include cathodes having a conductor, a basic electrolyte, and ammonia, ethanol, or combinations thereof.

It is contemplated that the plurality of hydrogen fuel cells are powered by the hydrogen produced by the plurality of electrochemical cells. The plurality of electrochemical cells are powered by the current produced by the fuel cells, enabling the electrochemical cells to produce hydrogen, using continuously supplied ammonia and/or ethanol feedstock.

Through use of the embodied hydrogen fuel cell and electrochemical cell stack, it is contemplated that a net power gain is obtained, such that the current produced by the fuel cells is in excess of the power required to fuel the electrochemical cells.

The present embodiments also relate to an electric consuming device assemblage that includes one or more electric consuming devices, such as motors.

The assemblage further includes one or more hydrogen fuel cells, as described previously, and one or more electrochemical cells, as described previously. The electrochemical cells produce hydrogen for powering the hydrogen fuel cells using ammonia and/or ethanol feedstock, while the hydrogen fuel cells produce current sufficient to power both the electrochemical cells and the electric consuming devices.

Controllers can be used to regulate the voltage applied to the electrochemical cells. A controller can also be used to regulate the pressure of the electrochemical cells, the fuel cells, or combinations thereof.

It is also contemplated that controllers can be used to regulate the temperature of the cells, the pH of the cells, the flow of ammonia and/or ethanol, and/or the heat flux of the cells.

Controllers are also useable to regulate the flow of gas out of the electrochemical cells and/or the load applied to the electrochemical cells.

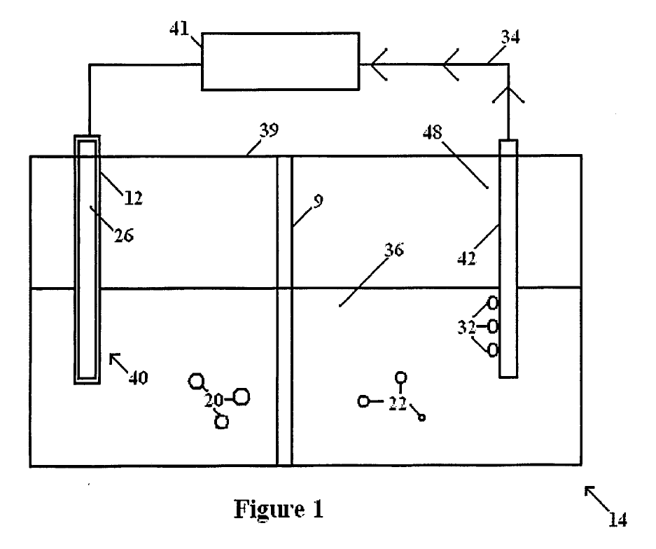

Referring now to FIG. 1, FIG. 1 depicts a diagram of the components of the present fuel cell (14).

The fuel cell (14) is depicted having a housing (39), which can be made from any nonconductive materials and have any size or shape necessary to accommodate the contents of the fuel cell (14).

An anode (40) is disposed within the housing (39). The anode is shown having a layered electrocatalyst (12) deposited on a carbon support (26). The layered electrocatalyst (12) is contemplated to include at least one active metal layer and at least one second metal layer. The layered electrocatalyst (12) is contemplated to enable the fuel cell (14) to be operable at low temperatures.

The fuel cell (14) further includes a basic electrolyte (36), such as sodium hydroxide or potassium hydroxide having a concentration ranging from 0.1M to 7M, disposed within the housing (39) adjacent the anode (40).

FIG. 1 further depicts the fuel cell (14) having a cathode (42) disposed within the housing (39) adjacent the basic electrolyte (36). The cathode (42) is contemplated to include a conductor.

The fuel cell (14) is also shown containing ammonia (20) and ethanol (22) within the basic electrolyte (36). It is contemplated that the fuel cell (14) can continuously utilize ammonia or ethanol individually, or simultaneously.

An oxidant (48), which can include air, oxygen, or combinations thereof, is disposed within the housing (39) in communication with the cathode (42), for connecting with a power conditioner (41), a load, or combinations thereof.

The power conditioner (41), load, or combinations thereof, is in communication with the anode (40), which oxidizes the ammonia (20), ethanol (22), or combinations thereof, allowing the fuel cell (14) to generate an electric current (34).

The depicted fuel cell (14) is shown having an ionic exchange membrane (9) disposed between the anode (40) and the cathode (42), which is contemplated to selectively permit hydroxide exchange.

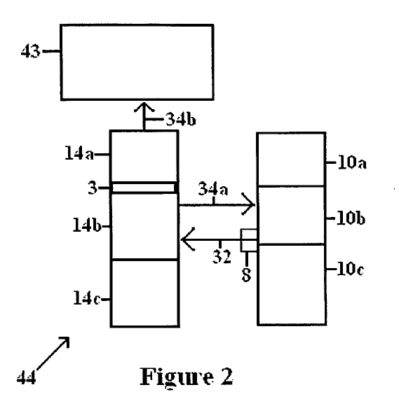

Referring now to FIG. 2, a diagram of an electric consuming device assemblage (44) is shown. The electric consuming device assemblage (44) is shown having an electric consuming device (43), a stack containing a plurality of electrochemical cells (10a, 10b, 10c), and stack containing a plurality of hydrogen fuel cells (14a, 14b, 14c).

A bipolar plate (3) is shown disposed between two adjacent fuel cells (14a, 14b). The bipolar plate can include one or more electrodes.

Hydrogen (32) from the electrochemical cells (10a, 10b, 10c) is used to fuel the plurality of hydrogen fuel cells (14a, 14b, 14c). The fuel cells (14a, 14b, 14c) produce electric current (34a, 34b), which is sufficient to power both the electrochemical cells (10a, 10b, 10c) and the electric consuming device (44).

A controller (8) is useable to regulate the voltage and/or current applied to the electrochemical cells (10a, 10b, 10c), and/or the flow of the hydrogen (32). The controller (8) is also useable to control the pressure, temperature, pH, flow of ammonia/ethanol, and/or the heat flux of the electrochemical cells (10a, 10b, 10c) and the fuel cells (14a, 14b, 14c).

While these embodiments have been described with emphasis on the embodiments, it should be understood that within the scope of the appended claims, the embodiments might be practiced other than as specifically described herein.

What is claimed is:

1. A fuel cell utilizing ammonia, ethanol, or combinations thereof, wherein the fuel cell comprises:
a housing;
an anode disposed within the housing, the anode comprising at least one layered electrocatalyst, wherein the at least one layered electrocatalyst comprises:
a carbon support integrated with a conductive metal;
at least one active metal layer at least partially deposited on the carbon support, wherein the at least one active metal layer is active to OH adsorption and inactive to ammonia, ethanol, or combinations thereof, and wherein the at least one active metal layer has a thickness ranging from 10 nanometers to 10 microns;
at least one second metal layer at least partially deposited on the at least one active metal layer, wherein the at least one second metal layer is active to ammonia, ethanol, or combinations thereof, and wherein the at least one second metal layer has a thickness ranging from 10 nanometers to 10 microns;
a basic electrolyte disposed within the housing adjacent the anode;
a cathode disposed within the housing adjacent the basic electrolyte, wherein the cathode comprises a conductor;
ammonia, ethanol, or combinations thereof disposed within the housing in communication with the anode; and
an oxidant disposed within the housing in communication with the cathode for connecting with a power conditioner, a load, or combinations thereof,
wherein the power conditioner, the load, or combinations thereof, is in communication with the anode which oxidizes the ammonia, ethanol, or combinations thereof, allowing the fuel cell to form a current.

2. The fuel cell of claim 1, wherein the ammonia, ethanol, or combinations thereof, has a concentration ranging from 0.01 M to 5.0 M.

3. The fuel cell of claim 1, wherein the ammonia, ethanol, or combinations thereof comprises a liquid, a gas, or combinations thereof.

4. The fuel cell of claim 1, wherein the oxidant comprises air, oxygen, or combinations thereof.

5. The fuel cell of claim 1, wherein the oxidant has a pressure ranging from less than 1 atm to 10 atm.

6. The fuel cell of claim 1, wherein the basic electrolyte has a volume that exceeds stoichiometric proportions of the reaction.

7. The fuel cell of claim 1, wherein the basic electrolyte has a concentration ranging from 0.1M to 7M.

8. The fuel cell of claim 1, wherein the concentration of basic electrolyte is 2 to 5 times greater than the concentration of the ammonia, ethanol, or combinations thereof.

9. The fuel cell of claim 1, wherein the active metal layer comprises, rhodium, rubidium, iridium, rhenium, platinum, palladium, copper, silver, gold, nickel, iron, or combinations thereof.

10. The fuel cell of claim 1, wherein the second electrode comprises carbon, platinum, rhenium, palladium, nickel, iridium, vanadium, cobalt, iron, ruthenium, molybdenum, or combinations thereof.

11. The fuel cell of claim 1, wherein the first and second electrodes each comprise a layered catalyst.

12. The fuel cell of claim 1, wherein the first electrode, the second electrode, or combinations thereof, comprise a rotating disc electrode, a rotating ring electrode, a cylinder electrode, a spinning electrode, an ultrasound vibration electrode, or combinations thereof.

13. The fuel cell of claim 1, further comprising an ionic exchange membrane or separator disposed between the anode and the cathode.

14. The fuel cell of claim 14, wherein the ionic exchange membrane or separator comprises polypropylene, polyamide, another polymer, copolymers thereof, glassy carbon, or combinations thereof.

15. A fuel cell stack comprising:
a plurality of fuel cells each in communication with an oxidant and a fuel supply, wherein the plurality of fuel cells is connected in series, parallel, or combinations thereof, wherein at least one of the fuel cells comprises an anode comprising at least one layered electrocatalyst, wherein the at least one layered electrocatalyst comprises:
a carbon support integrated with a conductive metal;
at least one active metal layer at least partially deposited on the carbon support, wherein the at least one active metal layer is active to OH adsorption and inactive to a target species, and wherein the at least one active metal layer has a thickness ranging from 10 nanometers to 10 microns; and
at least one second metal layer at least partially deposited on the at least one active metal layer, wherein the at least one second metal layer is active to the target species, and wherein the at least one second metal layer has a thickness ranging from 10 nanometers to 10 microns,
wherein the plurality of fuel cells generates electrical current when connected to a load.

16. The fuel cell stack of claim 15, wherein the at least one of the fuel cells further comprises:
a housing, wherein the anode is disposed in the housing;
a basic electrolyte disposed within the housing adjacent the anode;
a cathode disposed within the housing adjacent the basic electrolyte, wherein the cathode comprises a conductor.

17. The fuel cell stack of claim 15, further comprising a bipolar plate disposed between at least two of the fuel cells, wherein the bipolar plate comprises an anode electrode, a cathode electrode, or combinations thereof.

18. The fuel cell stack of claim 15, wherein the fuel cell stack has a cylindrical shape, a prismatic shape, a spiral shape, a tubular shape, or combinations thereof.

19. The fuel cell stack of claim 15, wherein the at least a first of the fuel cells further comprises:
a cathode comprising a conductor,
wherein at least a second of the fuel cells comprises:
a second anode comprising the at least one layered electrocatalyst,
and wherein the cathode functions as the cathode for both the first of the fuel cells and the second of the fuel cells.

20. The fuel cell stack of claim 15, wherein the fuel cell stack is operable at a pressure ranging from less than 1 atm to 10 atm, a temperature ranging from −50 degrees Centigrade to 200 degrees Centigrade, or combinations thereof.

21. A cell stack comprising:
a plurality of hydrogen fuel cells, each in communication with a load, an oxidant, and a fuel supply, wherein the plurality of hydrogen fuel cells is connected in series, parallel, or combinations thereof, wherein each of the hydrogen fuel cells comprises an anode comprising at least one layered electrocatalyst, and wherein the at least one layered electrocatalyst comprises:
a carbon support integrated with a conductive metal;
at least one active metal layer at least partially deposited on the carbon support, wherein the at least one active metal layer is active to OH adsorption and inactive to a target species, and wherein the at least one active metal layer has a thickness ranging from 10 nanometers to 10 microns;
at least one second metal layer at least partially deposited on the at least one active metal layer, wherein the at least one second metal layer is active to the target species, and wherein the at least one second metal layer has a thickness ranging from 10 nanometers to 10 microns;
a plurality of electrochemical cells, wherein at least one of the electrochemical cells comprises a first electrode comprising the at least one layered electrocatalyst,
wherein the plurality of electrochemical cells produces hydrogen for powering the plurality of fuel cells,
and wherein the plurality of fuel cells produces current sufficient to power the plurality of electrochemical cells while producing a net power gain.

22. An electric consuming device assemblage comprising:
at least electric consuming device;
at least one fuel cell, wherein the at least one fuel cell comprises an anode comprising at least one layered electrocatalyst, and wherein the at least one layered electrocatalyst comprises:
a carbon support integrated with a conductive metal;
at least one active metal layer at least partially deposited on the carbon support, wherein the at least one active metal layer is active to OH adsorption and inactive to a target species, and wherein the at least one active metal layer has a thickness ranging from 10 nanometers to 10 microns;
at least one second metal layer at least partially deposited on the at least one active metal layer, wherein the at least one second metal layer is active to the target species, and wherein the at least one second metal layer has a thickness ranging from 10 nanometers to 10 microns;
at least one electrochemical cell, wherein the at least one electrochemical cell comprises a first electrode comprising the at least one layered electrocatalyst,
wherein the at least one electrochemical cell produces hydrogen for powering the at least one fuel cell,
and wherein the at least one fuel cell produces current for powering both the at least one electrochemical cell and the at least one electric consuming device.

23. The electric consuming device assemblage of claim 22, further comprising a controller for regulating the voltage applied to the at least one electrochemical cell.

24. The electric consuming device assemblage of claim 22, further comprising a controller for regulating the pressure of the at least one electrochemical cell, the at least one fuel cell, or combinations thereof.

25. The electric consuming device assemblage of claim 22, further comprising a controller for regulating the temperature of the at least one electrochemical cell, the at least one fuel cell, or combinations thereof.

26. The electric consuming device assemblage of claim 22, further comprising a controller for regulating the pH of the at least one electrochemical cell, the at least one fuel cell, or combinations thereof.

27. The electric consuming device assemblage of claim 22, further comprising a controller for regulating the flow of ammonia, ethanol, or combinations thereof, into the at least one electrochemical cell, the at least one fuel cell, or combinations thereof.

28. The electric consuming device assemblage of claim 22, further comprising a controller for regulating the flow of resultant gas out of the at least one electrochemical cell.

29. The electric consuming device assemblage of claim 22, further comprising a controller for regulating load applied to the at least one electrochemical cell.

30. The electric consuming device assemblage of claim 22, further comprising a controller for regulating the heat flux of the at least one electrochemical cell, the at least one fuel cell, or combinations thereof.
